(19) United States
(12) Patent Application Publication
(10) Pub. No.: US 2025/0123172 A1
(43) Pub. Date: Apr. 17, 2025

(54) METHOD FOR DETECTING CONTAMINANTS/CONTAMINATION IN A PRESSURE SENSOR, AND PRESSURE SENSOR

(71) Applicant: Robert Bosch GmbH, Stuttgart (DE)

(72) Inventors: Alexander Schoenhals, Gomaringen (DE); Paul Fehling, Tuebingen (DE)

(21) Appl. No.: 18/905,186

(22) Filed: Oct. 3, 2024

(30) Foreign Application Priority Data
Oct. 11, 2023 (DE) 10 2023 209 971.3

(51) Int. Cl. G01L 27/00; G01L 19/06

(52) U.S. Cl. CPC G01L 27/007; G01L 19/0645

(57) ABSTRACT

A method for detecting contamination in a pressure sensor comprising at least two pressure detection membranes whose electrostatic and/or electrodynamic state depends on the external pressure. The method includes: detecting a membrane state by each of the at least two pressure detection membranes; comparing one or more state differences between each value of the detected membrane states with a predetermined threshold value; if at least one of the state differences exceeds the predetermined threshold value, outputting that at least one of the membranes is contaminated.

### CROSS REFERENCE

The present application claims the benefit under 35 U.S.C. § 119 of German Patent Application No. DE 10 2023 209 971.3 filed on Oct. 11, 2023, which is expressly incorporated herein by reference in its entirety.

### FIELD

The present invention relates to the field of pressure sensors, in particular to a system and a method for detecting contaminants on or within a pressure sensor using the alignment of a plurality of pressure membranes.

### BACKGROUND INFORMATION

KR 101921843B1 relates to a suspended membrane for a capacitive pressure sensor.

Pressure sensors play a critical role in a variety of industries, from meteorology to automotive applications. They measure pressure by detecting the effect of a force acting on a specific reference surface or membrane, commonly called a pressure membrane. The precision and reliability of these measurements are of utmost importance as they can directly impact systems or processes that depend on them.

Traditionally, pressure sensors have had to deal with contaminants or contamination, be it in the form of particles or liquids. When these contaminants come into contact with the pressure membrane, they exert additional force effects on it. These external forces can be caused by various factors. For example, the mass of the contaminant combined with the effects of gravity or external acceleration can change the force profile on the membrane. This disturbance distorts the pressure state information/pressure signal and leads to inaccurate measurements.

To counteract the problems caused by contamination, the related art in the development of pressure sensors has often provided additional technical elements or functions. These additions have been specifically integrated to detect and potentially mitigate the effects of contaminants or contamination. Although this approach is functional, it also has its limitations. It often increases the complexity of the sensor design, can increase production costs, and may require additional effort for maintenance or calibration.

Therefore, there is a need in the industry for a leaner, more efficient and cost-effective solution to the problem of contamination, without the disadvantages associated with integrating additional technical elements.

In this context, the present invention provides an approach for detecting contaminants/contamination in pressure sensors. This method utilizes the capabilities of sensors equipped with multiple pressure membranes and takes advantage of their inherent design to detect and correct discrepancies caused by contamination.

### SUMMARY

The present invention provides an innovative method for detecting contaminants, in particular liquids or particles, in pressure sensors, and provides a pressure sensor. This is achieved by utilizing the inherent capabilities of sensors equipped with at least two pressure membranes, as opposed to adding additional technical elements or functions that are common in conventional designs.

The present invention is based on a comparison-based approach that evaluates the pressure state information/pressure signals generated by each of these pressure membranes. When contaminants come into contact with or near the pressure membranes, they can exert different force effects on these membranes, especially when the inertia of the contaminants, gravitational influences, or external accelerations are taken into account. The resulting variations in the pressure state information/pressure signals between the different membranes can be analyzed to infer the presence of contaminants.

However, there are natural differences in the pressure state information/pressure signals of different membranes, even if they are flawless, due to factors such as manufacturing tolerances. To take this inherent deviation into account, the present invention provides a threshold value for the permissible difference between the pressure state information/pressure signals of the membranes. This threshold value can originate from production data, be set when the system is initialized, or be continuously recalibrated based on long-term observations or other influencing factors.

Preferred developments of the present invention are disclosed herein.

An advantage of the approach according to the present invention is its adaptability to pressure sensors, regardless of whether their pressure membranes are designed for the same or different pressure ranges. The present invention provides specific discrepancy criteria for both design variants, thus facilitating the detection of contaminants/contamination in a variety of scenarios.

Furthermore, the present invention remains versatile and efficient in detecting contaminants in different types of contamination, sensor shapes, or pressure membrane configurations. While certain conditions, such as the exact central positioning of a particle between the membranes, could theoretically prevent/make more difficult the detection of contamination, the sensitivity of the present invention in comparing pressure state information/pressure signals and taking into account their evolution over time significantly minimizes such cases.

This approach of the present invention also has an advantage of eliminating the need for additional components and allowing the pressure sensor to remain simple and lightweight, since contamination detection is integrated into the inherent system. This also reduces the cost of such a device, as additional functional modules are not required.

Another advantage is that the approach of the present invention can be used in real time. Because it uses the continuous measurements of the pressure membranes, contamination can be detected almost immediately, allowing immediate corrective action.

For products equipped with other sensors such as accelerometers or gyroscopes, the pressure sensor data can be merged with the data from these additional sensors to improve the accuracy of contamination detection. This process, often referred to as sensor fusion, refines the understanding of the environment and distinguishes between cases such as static tilts or dynamic accelerations.

For example, the data from an accelerometer of the product could be used for sensor fusion. From this, it can be deduced when a greater force effect due to possible contamination is to be expected due to gravity (e.g. when the sensor is tilted) or lateral acceleration on one side/membrane of the MEMS.

In a further embodiment of the present invention, this information from other sensors in the overall system could also be used to trigger the measurement for contamination detection when the product/sensor is in a favorable position/location.

### BRIEF DESCRIPTION OF THE DRAWINGS

FIGS. 1A and 1B show a pressure sensor with two membranes operating in the same pressure range, according to an example embodiment of the present invention.

FIG. 2A to 2F show a pressure sensor with two membranes operating in different pressure ranges, according to an example embodiment of the present invention.

FIG. 3A to 3D illustrate the effects of contamination by liquid and show the functioning when the size or positioning of the contamination is asymmetrical.

FIGS. 4A and 4B illustrate the effects of contamination by liquid and show that a tilting of the pressure device has no influence on the validity of the approach according to the present invention.

FIG. 5 illustrates the case of contamination by a particle.

FIG. 6 is a diagram showing a method of detection according to and example embodiment of the present invention.

FIG. 7 is a schematic drawing showing a pressure sensor according to an example embodiment of the present invention.

### DETAILED DESCRIPTION OF EXAMPLE EMBODIMENTS

Example embodiments of the present invention are described in detail below with reference to the figures.

The present invention provides a new method for detecting contamination in pressure sensors. The present invention, which previously relied on additional technical components, uses the intrinsic properties of pressure sensors equipped with at least two pressure membranes.

The central elements in the approach of the present invention are the pressure membranes. These membranes are essentially structures (e.g. thin films or layers) whose mechanical state (e.g. the mechanical tension in the material, or the deflection from the rest position) is influenced by the force effect of the ambient pressure. The measurement of specific electrical properties/states that are linked to the mechanical state allows conclusions to be drawn about the ambient pressure.

Various types of pressure sensors can be used for the present invention. An advantageous variant consists of a plurality of components (e.g. connected with bonding wires): a sensor element/MEMS (micro-electro-mechanical system) with the pressure membranes, an evaluation circuit/ASIC (application-specific integrated circuit) which is connected to the MEMS and the substrate (for media robustness, substrate with solder contacts for installation in the end device, . . . ). The sensor element/MEMS is designed to convert the physical environmental conditions (here the ambient pressure) into an electrically measurable property. The MEMS membranes can be designed as capacitors whose capacitance depends directly on the ambient pressure. In this type of embodiment, the MEMS itself does not generate a signal, but only changes its (passive) electrical properties. The ASIC can measure the electrical state of the MEMS by applying a voltage signal (e.g. a constant or time-varying one) and detecting the current flow. In one embodiment, a square wave voltage can be applied to one side, and the current can be measured over time at the other side. In the ASIC, special conversion formulas are then applied to the measured value to convert the MEMS state (i.e. the capacitance) into an actual pressure value and to compensate for influences (e.g. temperature). This pressure value can then be read via the solder contacts on the substrate.

In the context of the present invention, the pressure sensor contains at least two such membranes. Each of these membranes generates its own pressure state information (or pressure signal, if this information is detected by a device that converts it into an electrical signal), even though it is exposed to the same external environment. This pressure state information/these signals should ideally be synchronous under the conditions of the intended operating range, as they are subject to the same external forces. However, deviations due to differences in manufacturing and other external influences may result in small discrepancies in these measured values.

Contaminants such as liquids or particles that come into contact with or are near these pressure membranes exert different force effects. These forces, which are primarily due to the mass of the contaminants and are amplified by external factors such as gravity or other accelerations, lead to pronounced force effects on the pressure membranes. Consequently, the pressure state information/pressure signals generated by each of these membranes would exhibit noticeable deviations in the presence of contaminants.

To distinguish these discrepancies caused by contaminants from natural information differences/signal differences, the present invention uses a threshold value approach. This value represents the maximum permissible difference between the information/signals of the pressure membranes. If the difference exceeds this threshold value, it becomes an indicator of contamination.

The determination of the threshold value can be dynamic and can draw from a variety of sources. First, data obtained during the manufacturing phase can provide insight into the inherent discrepancies in the pressure state information/pressure signals that are due to manufacturing nuances. When the pressure sensor system is put into operation, the initial measured values also provide a fundamental basis for detecting information differences/signal differences. As the service life of the sensor progresses, factors such as sensor deviations or changing environmental conditions may make regular recalibration necessary. Therefore, the system is designed to be able to continuously update this threshold value to ensure its accuracy and relevance.

The present invention can be applied in a versatile manner to a variety of sensor designs. For example, sensors can have pressure membranes that are designed for the same or different pressure ranges. In both cases, the present invention provides specific discrepancy criteria.

For sensors with membranes designed for the same pressure range, contamination detection revolves around the pressure state information/signal differences simply exceeding a threshold value. However, for sensors with membranes for different pressure ranges, the criteria are more nuanced. Not only must the information/signal difference exceed the threshold value, but none of the pressure state information/pressure signals should be at the limit of the relevant pressure range.

Regardless of the type or nature of the contamination, the present invention shows remarkable efficiency in detection. Regardless of whether it is a liquid or particles, the changes in the pressure state information/pressure signal remain perceptible.

Even if liquids wet symmetrically arranged pressure membranes evenly, the present invention can detect discrepancies. A slight tilt of the sensor, a deviation of the membranes from the horizontal plane, or an external movement or acceleration can lead to deviations in the pressure state information/pressure signals, indicating the presence of contamination.

Furthermore, the sensitivity of the present invention is not limited to the instantaneous comparison of pressure state information/signals. By analyzing the curve of this pressure state information/these signals over a determined period of time, even subtle contamination becomes apparent.

In systems that contain not only pressure sensors but also other components such as accelerometers or gyroscopes, the present invention can combine the data streams from all these sources. This merging, called “sensor fusion,” refines the detection of contamination and makes it possible to ascertain the exact cause of information/signal deviations, whether due to static positioning or dynamic movements.

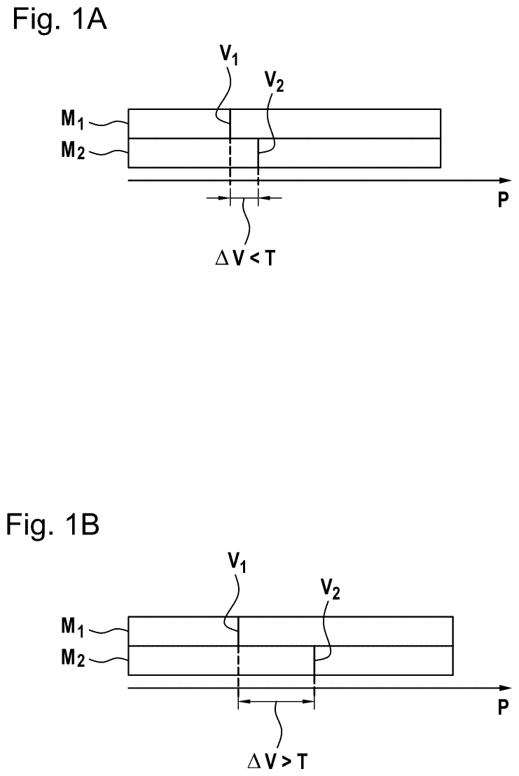

FIGS. 1A and 1B show a pressure sensor with two membranes operating in the same pressure range, according to an embodiment of the present application.

Pressure sensors having multiple membranes can have membranes operating in the same pressure range. In this case, each membrane is deformed and sends an item of information/a signal corresponding to this deformation in the same detection range. Since the two membranes have manufacturing tolerances as explained above, it is probable that there is a slight difference between the information/signals from the two membranes in the pressure detection range they both use. This means that a threshold value can be determined which corresponds to the difference between the two items of pressure state information/signals in the valid operating mode (i.e. in operation without contamination). As long as the difference between the two items of information/signals does not exceed this threshold value, it can be assumed that the membranes are, theoretically, not contaminated. However, if the difference between the two items of information/signals exceeds such a threshold value, this theoretically means that at least one of the membranes is contaminated. FIG. 1A shows the case in which a first membrane M1 and a second membrane M2 are not contaminated. The square boxes indicate the pressure detection range, and the arrow indicates the pressure value P. The first item of pressure state information/signal of the first membrane M1 has a value V1, and the second item of pressure state information/signal of the second membrane M2 has a value V2. In this example, the difference ΔV between V1 and V2 remains below the threshold value T. FIG. 1B shows a case of contamination, since in this example the difference of the pressure value ΔV between V1 and V2 exceeds the threshold value T.

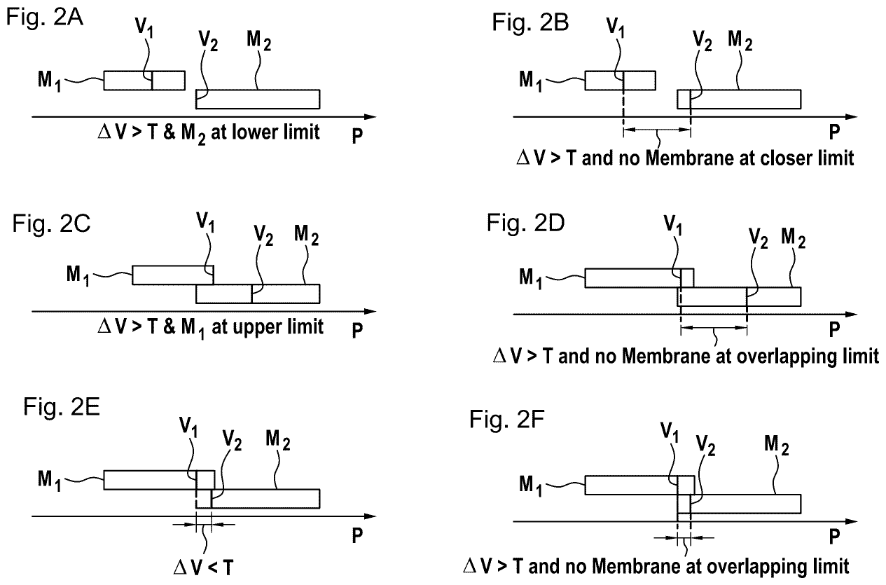

FIG. 2A to 2F show a pressure sensor with two membranes operating in different pressure ranges, according to an embodiment of the present application. In this embodiment, there is still a detection condition for the threshold value T, which exceeds the pressure difference ΔV between V1 and V2. However, there is a second and cumulative condition for the position of the values with respect to the limit of the ranges.

FIGS. 2A and 2B relate to the case of two membranes with non-overlapping ranges. It can be seen that the square boxes on the P axis are not continuous, indicating that they are configured to measure in different pressure detection ranges, with a portion of the total range where no detection occurs. In FIG. 2A, the value V1 is contained in the first range, while the value V2 is at the lower limit of the detection range of the membrane M2. This illustrates a case where no contamination is detected. In this case there is no detection because V2 is at the lower limit of the range, which can explain why the two values are so far apart and there is no contamination. FIG. 2B illustrates a case in which the fact that the difference in the pressure value ΔV between V1 and V2 exceeds the threshold value T is not caused by the detection gap between the two ranges. In the case of FIG. 2b, there is contamination of at least one membrane.

FIGS. 2C and 2D relate to the case of two membranes with overlapping ranges. It can be seen that the square boxes overlap on the P axis. This means that they are configured to measure in different pressure detection ranges, with part of the total range being detected by both membranes. In FIG. 2C, the value V1 is at the upper limit of the first range, while the value V2 is in the detection range of the membrane M2. This illustrates a case where no contamination is detected. In this case, there is no detection because V1 is at the upper limit of the range, which can explain why the two values are so far apart and there is no contamination. FIG. 2B illustrates a case of contamination where the difference in pressure value ΔV between V1 and V2 exceeds the threshold value T and this is not caused by the detection range of the membrane M1 being too short to calculate a true difference between the values V1 and V2.

FIGS. 2E and 2F also relate to the case of two membranes with overlapping ranges. In FIG. 2E, the value V1 lies in the detection range of the membrane M1, while the value V2 lies in the detection range of the membrane M2. This illustrates a case where no contamination is detected. The two values V1 and V2 are valid insofar as they are each in the corresponding detection range of their membrane, where the pressure value ΔV between V1 and V2 does not exceed the threshold value T. Here too, V1 and V2 are within the detection range of their associated membranes. However, the difference in the pressure values ΔV between V1 and V2 exceeds the threshold value T, and this is not due to problems with the detection ranges that are not adapted to the situation.

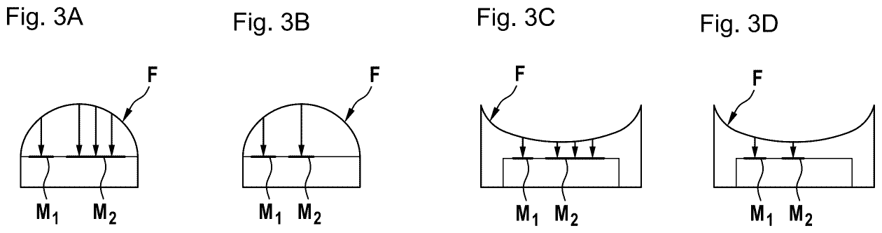

FIG. 3A to 3D illustrate the effects of contamination by liquid and show that asymmetrical size or positioning does not affect the validity of the approach according to the present invention. The length of the arrow represents the strength of the force exerted on the membrane.

FIGS. 3A and 3B show two cases corresponding to two configurations of the membranes. In FIG. 3A, the second membrane M2 has a larger width and occupies a larger space in the horizontal direction. In FIG. 3B, the two membranes have the same size, but M1 is located on the left side of the device while M2 is in the middle. In both cases there is contamination by a liquid F, which is deposited on the sensor pressure in the same way. In both cases, a calculation of the difference ΔV between V1 and V2 is possible and can be used for a comparison with the threshold value.

FIGS. 3C and 3D show two cases corresponding to the same two configurations of the membranes as in FIGS. 3A and 3B. The difference lies in the form of the liquid contamination. Here too, in both cases a calculation of the difference ΔV between V1 and V2 is possible and can be used for a comparison with the threshold value.

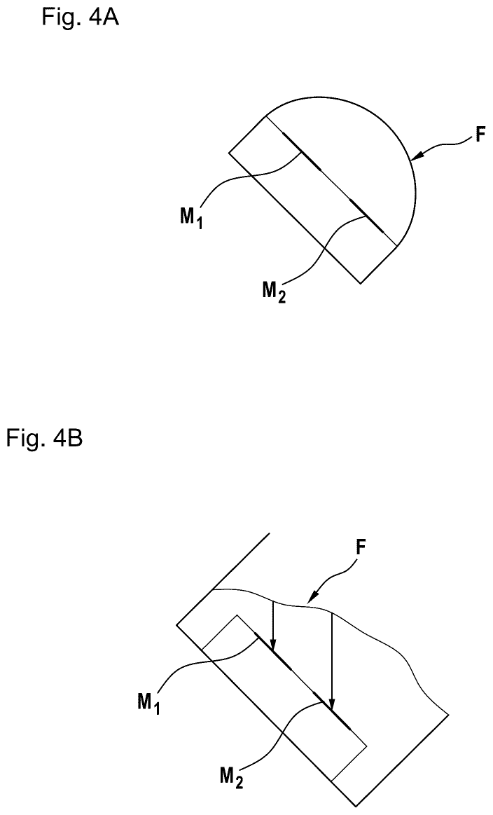

FIGS. 4A and 4B illustrate the effect of contamination by liquid and show that a tilting of the pressure device has no influence on the validity of the approach according to the present invention. Here too, in both cases a calculation of the difference ΔV between V1 and V2 is possible and can be used for a comparison with the threshold value.

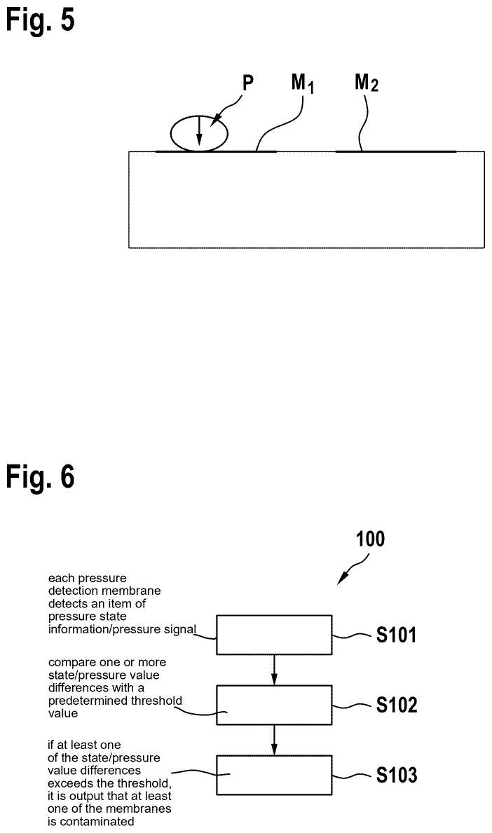

FIG. 5 illustrates the case of contamination by particles P located on the membrane M1. The arrow shows the additional force exerted on the membrane M1.

FIG. 6 is a diagram showing a method 100 for detection according to the present application.

In a first step S101, each of the at least two pressure detection membranes M1, M2 detects an item of pressure state information/pressure signal with a pressure value V1, V2, e.g. by detecting an electrostatic and/or electrodynamic state (membrane states). In a second step S102, one or more state/pressure value differences ΔV between each pressure state/pressure value V1, V2 of the detected pressure state information/pressure signals are compared with a predetermined threshold value T, and the difference is ascertained. Subsequently, in a third step S103, if at least one of the state/pressure value differences ΔV exceeds the predetermined threshold value T, it is output that at least one of the membranes is contaminated.

The steps of comparing S102 and outputting S103 can be performed by a comparison and output module of the sensor. In this case, the comparison and output module of the sensor can be either analog and/or digital, and can comprise an electrical, acoustic, or visual output module for outputting the signal of a contamination. Alternatively, these steps of comparison S102 and/or outputting S103 can be performed by a system that is external to the pressure sensor and is connected to the pressure sensor in order to receive the pressure signals or the result of the comparison step.

The method allows the membrane states/pressure values V1, V2 to be averaged over a certain period of time, and the comparison can be made based on the average values of the membrane states/pressure values.

With this method, the threshold value T can be ascertained based on the manufacturing tolerance measured at the membranes M1, M2. It can also be updated with a predefined frequency.

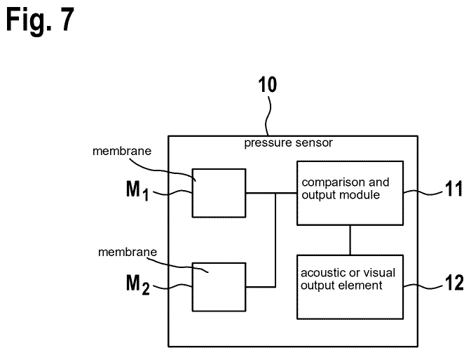

FIG. 7 is a schematic drawing showing a pressure sensor 10 according to an embodiment of the present application. The pressure sensor comprises two membranes M1 and M2 connected to a comparison and output module 11, which can be analog or digital. The comparison and output module 11 can be connected to an acoustic or visual output element 12 in order to issue the output in the form of an acoustic or visual signal.

What is claimed is:

1. A method for detecting contamination in a pressure sensor, wherein the sensor includes at least two pressure detection membranes whose electrostatic and/or electrodynamic state depends on the external pressure, the method comprising the following steps:
detecting an electrostatic and/or electrodynamic membrane state of each of the at least two pressure detection membranes;
comparing the detected states and determining their difference;
comparing one or more state differences between each of the detected membrane states with a predetermined threshold value;
outputting, when at least one of the state differences exceeds the predetermined threshold value, that at least one of the membranes is contaminated.

2. The method according to claim 1, wherein the steps of comparing and outputting are performed by a comparison and output module/evaluation circuit of the pressure sensor.

3. The method according to claim 1, wherein the comparison and output module of the pressure sensor is analog and/or digital and includes an electrical output element or an acoustic out element or visual output element.

4. The method according to claim 1, wherein the membrane states are averaged over a period of time, and the step of comparing is performed using average values of the membrane states.

5. The method according to claim 1, wherein the contamination is caused by liquid or particles on at least one of the pressure detection membranes.

6. The method according to claim 1, wherein the threshold value is determined based on manufacturing tolerance measured at the pressure detection membranes, or from production data of a manufacturer or user, when the electronic system is commissioned.

7. The method according to claim 1, wherein the threshold value is updated/recalibrated with a predefined frequency.

8. The method according to claim 1, wherein the pressure detection membranes have the same or different pressure measuring ranges.

9. The method according to claim 1, wherein the steps of comparing and/or outputting are performed by a system that is connected to the pressure sensor and that receives the pressure signals or the result of the comparison step.

10. A pressure sensor, comprising:
at least two pressure detection membranes;
wherein the sensor is configured to:
detect an electrostatic and/or electrodynamic membrane state of each of the at least two pressure detection membranes,
compare the detected states and determining their difference,
compare one or more state differences between each of the detected membrane states with a predetermined threshold value,
output, when at least one of the state differences exceeds the predetermined threshold value, that at least one of the membranes is contaminated.
